(19) United States
(12) Patent Application Publication
(10) Pub. No.: US 2012/0249281 A1
(43) Pub. Date: Oct. 4, 2012

(54) INDUCTOR AND EDDY CURRENT SENSOR INCLUDING AN INDUCTOR

(75) Inventors: Lam CAMPBELL, Minden, NV (US); Aaron J. Knobloch, Niskayuna, NY (US); Sherrie Clark, Minden, NV (US); Dan Tho Lu, Minden, NV (US); Richard Dale Slates, Minden, NV (US); David William Vernooy, Niskayuna, NY (US)

(73) Assignee: GENERAL ELECTRIC COMPANY, Schenectady, NY (US)

(21) Appl. No.: 13/079,404

(22) Filed: Apr. 4, 2011

(51) Int. Cl. H01F 5/00

(52) U.S. Cl. 336/200

(57) ABSTRACT

An inductor and an eddy current sensor including an inductor are disclosed. The inductor includes a patterned metal layer arranged on an insulating substrate. The inductor is capable of sensing eddy current within a high temperature region.

### FIELD OF THE INVENTION

The present invention is directed to inductors and articles and systems including inductors, more particularly, inductors capable of measuring eddy currents.

### BACKGROUND OF THE INVENTION

Eddy current are currents induced in conductors that are generated by a changing magnetic field. Relative motion of the magnetic field and the conductor causes a circulating flow of current known as eddies. These eddies create induced magnetic fields that oppose the changing magnetic field. The induced magnetic fields can be used for measuring vibration, position sensing, metal separating, induction heating, non-destructive testing of conductive materials, or other applications.

Known eddy current sensors include inductors for measuring eddy current. Generally, the eddy current sensors include a coiled wire, such as enamel coated wire, wrapped around a bobbin, such as a ferrite bobbin. Such eddy current sensors suffer from several drawbacks. For example, the wrapping of the wire around the bobbin can be inconsistent from one inductor to another. Such inconsistencies can require complicated procedures for utilizing the inductor in an eddy current sensor. Also, in high temperature environments, the wire can unravel from the bobbin and/or tension in the wire can result in undesirable tensile effects on the wire. As such, many eddy current sensors are only operable between about −25° C. (−13° F.) and about 175° C. (347° F.) and some are operable only within narrower ranges.

An inductor and an eddy current sensor including an inductor that do not suffer from the above drawbacks would be desirable in the art.

### BRIEF DESCRIPTION OF THE INVENTION

In an exemplary embodiment, an inductor includes a patterned metal layer arranged on an insulating substrate. The inductor is capable of sensing eddy current of a region, the region being at a temperature up to about 500° C. (932° F.).

In another exemplary embodiment, an inductor includes a patterned metal layer on an insulating substrate and a conductive material on the patterned metal layer. The inductor is capable of sensing eddy current of a region, the region being at a temperature up to about 500° C. (932° F.).

In another exemplary embodiment, an eddy current sensor includes a transducer having an inductor. The inductor includes a patterned metal layer arranged on an insulating substrate. The inductor is capable of sensing eddy current of a region, the region being at a temperature up to about 500° C. (932° F.).

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view from above of an exemplary inductor according to the disclosure.

FIG. 2 shows a perspective view from below of an exemplary inductor according to the disclosure.

FIG. 3 shows a perspective view of an exemplary inductor according to the disclosure.

FIG. 4 shows a sectional view of an exemplary eddy current sensor according to the disclosure.

FIG. 5 shows a sectional view of an exemplary eddy current sensor according to the disclosure.

Wherever possible, the same reference numbers will be used throughout the drawings to represent the same parts.

### DETAILED DESCRIPTION OF THE INVENTION

Provided is an inductor and an eddy current sensor including an inductor that do not suffer from one or more of the above drawbacks. Embodiments of the disclosure permit measurement of vibration, position sensing, metal separating, non-destructive testing of conductive materials, consistency from one inductor to another, simplified procedures for utilizing the inductor in an eddy current sensor, operation in high temperatures, and combinations thereof.

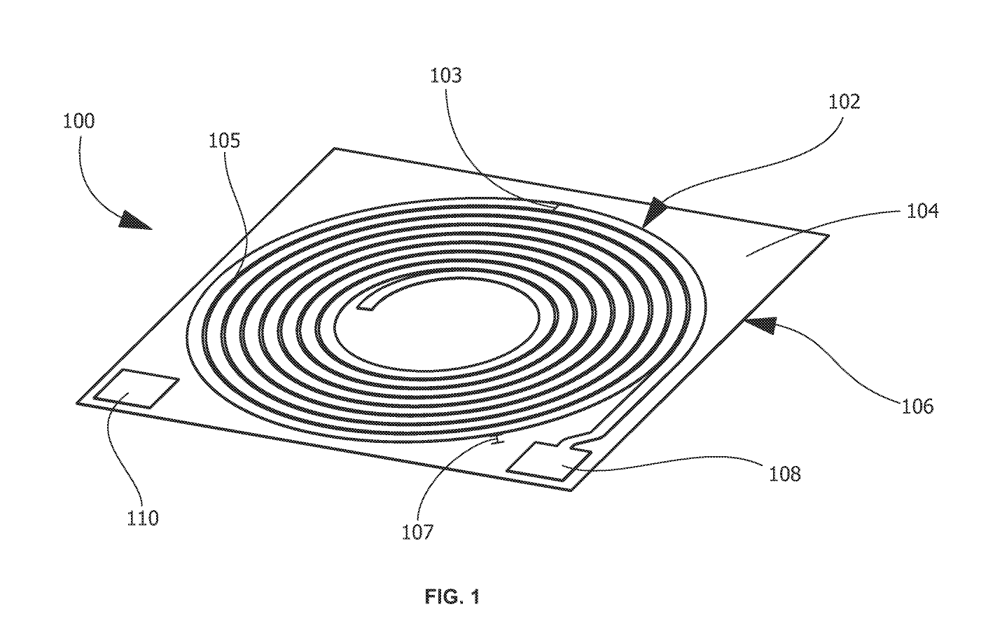

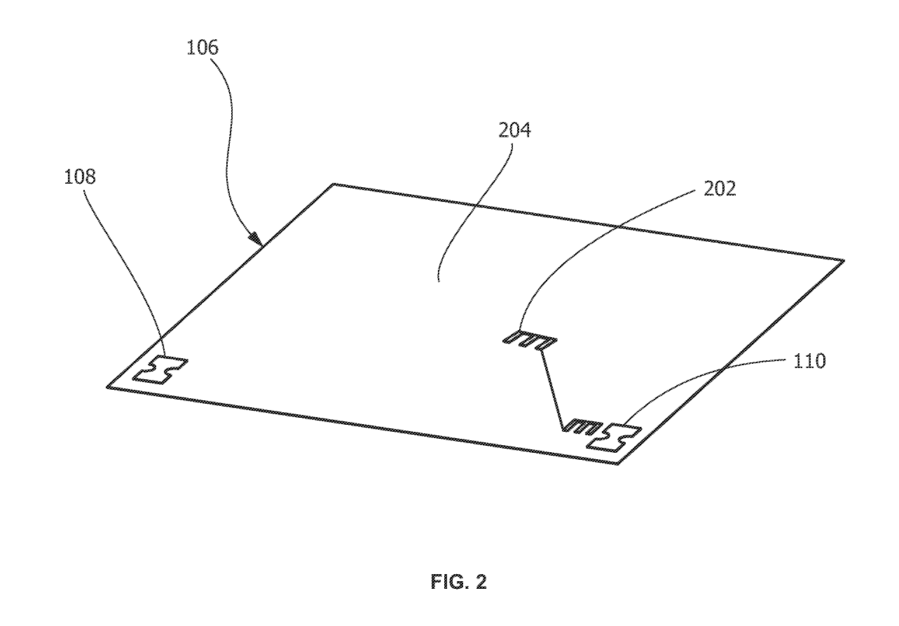

FIGS. 1 and 2 show an exemplary embodiment of an inductor 100. As shown in FIG. 1, the inductor 100 includes a patterned metal layer 102 arranged on a first surface 104 of an insulating substrate 106. The patterned metal layer 102 is any suitable pattern. Suitable patterns include, but are not limited to, spirals, rectilinear spiral-like paths, and other geometric arrangements capable of providing an inductive effect. In one embodiment, the pattern includes a predetermined number of turns. As used herein, the term “turn” refers to a path extending along 360 degrees from a central reference point. For example, in a spiral pattern, the turns extend in a substantially spiraling manner around the central reference point. In a rectilinear spiral-like path, the turns extend in a substantially spiraling rectilinear manner around the central reference point. For example, in one embodiment, the pattern includes 16 turns on one layer. In another embodiment, the pattern includes 32 turns on two layers, with 16 turns on each layer. In other embodiment, more than 16 turns are included on one layer and/or more than 32 turns are included in the overall pattern for the inductor 100.

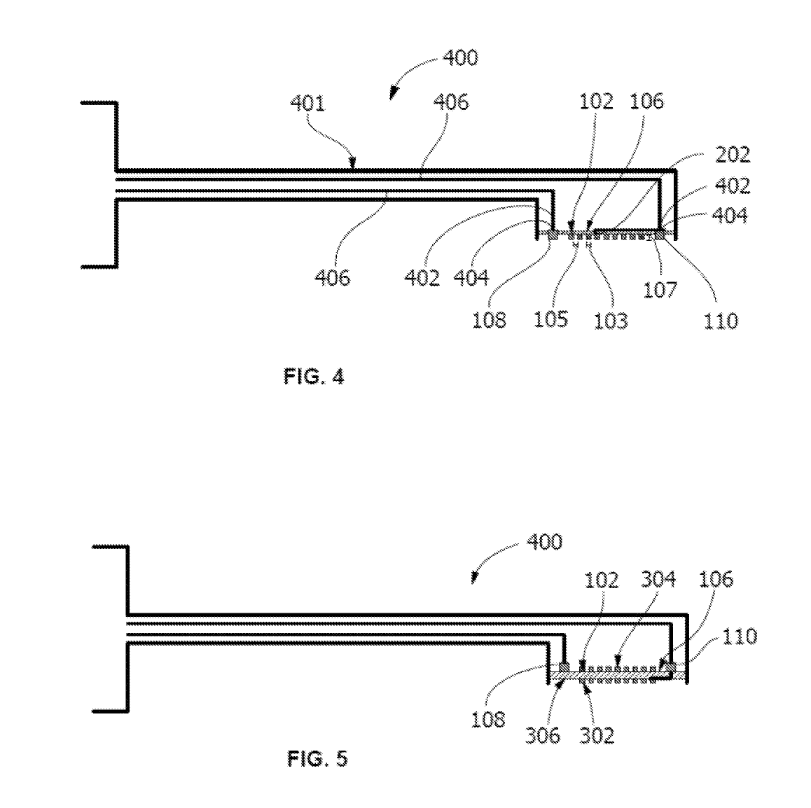

In one embodiment, as shown in FIGS. 1 and 4, the patterned metal layer 102 includes a predetermined trace width 103 (the thickness taken in a radial direction along the path of the pattern), a predetermined trace spacing 105 (the spacing between portions taken in a radial direction along the path of the pattern), and a predetermined depth 107 (the distance from the insulating substrate 106 to applied patterned metal layer 102). In one embodiment, the predetermined trace width 103 is between about 240 micrometers (about 0.00944 inches) and about 267 micrometers (about 0.0105 inches) or at about 254 micrometers (0.010 inches). In one embodiment, the predetermined trace spacing 105 is between about 216 micrometers (about 0.00850 inches) and about 190 micrometers (about 0.00748 inches) or at about 203 micrometers (about 0.00799 inches). In one embodiment having a spiral-shaped pattern, the predetermined depth 107 is between about 19 micrometers (about 0.000748 inches) and about 35 micrometers (0.00138 inches), between about 19 micrometers (about 0.000748 inches) and about 26 micrometers (about 0.00102 inches) on the interior of the spiral-shaped pattern, between about 29 micrometers (about 0.00114 inches) and about 35 micrometers (about 0.001378 inches) on the exterior of the spiral-shaped pattern, about 22 micrometers (about 0.000866 inches) on the interior of the spiral-shaped pattern, and about 31 micrometers (about 0.00122 inches) on the exterior of the spiral-shaped pattern.

The patterned metal layer 102 is not limited to metal materials and includes any suitable inductive materials. Suitable materials for the patterned metal layer 102 include, but are not limited to, platinum, molybdenum, tungsten, tantalum, nickel, titanium, copper, chromium, gold, aluminum, silver or other conductive materials appropriate for the operating temperature. In one embodiment, the patterned metal layer 102 includes a seed layer of platinum thick film, for example, about 10 micrometers (about 0.000393 inches), and a plating of 99.9% platinum, for example, about 25 micrometers (about 0.000984 inches). The seed layer provides adhesion by migration into the insulating substrate 106. The plating provides consistency by having substantially consistent depth throughout the patterned metal layer 102. In one embodiment, the patterned metal layer 102 includes additives for adhesion and/or impurities, which may or may not be metal. For example, the patterned metal layer 102 may include ceramics, such as alumina.

In one embodiment, the platinum seed layer provides adhesion and peel strength. In this embodiment, low enough resistance and consequently a desirable performing inductive effect and/or eddy current effects (for example, a desired Q according to the equation Q=wL/R, where Q represents the amount an oscillator or resonator is under-damped, w is the angular frequency, L is the inductance, and R is the resistance) are achieved by using electroplated platinum, for example, at an average about 25.4 micrometers (about 0.001 inches), and/or multiple silk screening passes to construct a thicker conductor thereby decreasing resistance. Electroplating permits control of the turn-to-turn spacing as the build-up causes the conductor cross-section to “mushroom” thus reducing the predetermined trace spacing 105. In one embodiment, the electroplating includes the predetermined trace spacing 105 (and consequently total inductance) and a predetermined build-up height (and total resistance). Multiple passes of silk screening include each layer being fired or cured and each additional layer being deposited until a predetermined average thickness, for example, a 25.4 micrometers (about 0.001 inch) thickness or a thickness of at least 25.4 micrometers (about 0.001 inches), is constructed. Silk screening registration includes each progressive pass being thinner (in a radial direction) than the prior pass.

The insulating substrate 106 is any suitable electrically insulating material. Suitable materials for the insulating substrate 106 include, but are not limited to, alumina (for example, 92% alumina), aluminum nitride, borosilicate glass, quartz, sialon, low-temperature co-fired ceramic, silicon nitride, alumina, silicon carbide, sapphire, zirconia, or other suitable insulating materials. In one embodiment, the insulating substrate 106 has a predetermined geometry and dimensions, for example, a substantially square geometry having dimensions of about 2.5 cm (about 0.98 inches) to about 2.6 cm (about 1.0 inches) or about 2.55 cm (about 1.00 inches) or any other suitable geometry and dimensions capable of supporting the patterned metal layer 102. In one embodiment, the insulating substrate 106 has a predetermined thickness, for example, about 1,550 micrometers (about 0.06102 inches) to about 1,800 micrometers (about 0.07087 inches) or about 1,675 micrometers (about 0.06594 inches. In one embodiment, the insulating substrate 106 has a predetermined flatness, for example, about 75 micrometers (about 0.0030 inches).

Referring to FIG. 2, a via 202 extends through the insulating substrate 106 from the patterned metal layer 102 onto a second surface 204. The via 202 includes any suitable conductive materials. Suitable materials for the via 202 include, but are not limited to, platinum, molybdenum, tungsten, tantalum, nickel, titanium, copper, chromium, gold, aluminum, silver, or other suitable conductive materials. In one embodiment, the via 202 and the patterned metal layer 102 include the same material. In one embodiment, the via 202 has a predetermined diameter, for example, about 230 micrometers (about 0.00906 inches) to about 280 micrometers (about 0.0110 inches) or about 255 micrometers (about 0.0100 inches).

The patterned metal layer 102 is operably connected to a first conductive pad 108 on the first surface 104 and the via 202 is operably connected to a second conductive pad 110 on the second surface 204. The first conductive pad 108 and/or second conductive pad 110 include any suitable nickel-based alloy, titanium-based alloy, tungsten-based alloy, gold-based alloy, molybdenum-based alloy, or other conductive metal. Through measurement of current between the first conductive pad 108 and the second conductive pad 110, the inductor 100 is capable of sensing changes in eddy current that, in turn, permit measurement by an eddy current sensor 400 (discussed below with reference to FIG. 4) in any suitable high-temperature region, for example, including, but not limited to, a gas turbine component, a steam turbine component, a combustion region, a high-temperature region, a hot manufactured product, or any other region.

The inductor 100 includes predetermined electrical properties permitting measurement of the eddy current. For example, in one embodiment, at about 25° C. (about 77° F.) the inductor 100 includes inductance at 2 Mhz greater than 1.4 microHenries, greater than 1 Q, Rdc greater than 1, resistance at 2 Mhz greater than 100, max Ipk of 15 mA, isolation greater than 10M, and combinations thereof. In one embodiment, the inductor 100 accurately and/or precisely senses eddy current changes throughout a predetermined temperature or temperature range, for example, up to about 500° C. (about 932° F.), up to about 800° C. (about 1472° F.), up to about 980° C. (about 1796° F.), up to about 1000° C. (about 1832° F.), up to about 1200° C. (about 2192° F.), up to about 1400° C. (about 2552° F.), up to about 1500° C. (about 2732° F.), between about −40° C. (about −40° F.) and about 500° C. (about 932° F.), between about −40° C. (about −40° F.) and about 980° C. (about 1796° F.), between about −40° C. (about −40° F.) and about 1000° C. (about 1832° F.), between about −40° C. (about −40° F.) and about 1500° C. (about 2732° F.). In one embodiment, the inductor 100 accurately and/or precisely senses eddy current changes at a predetermined humidity.

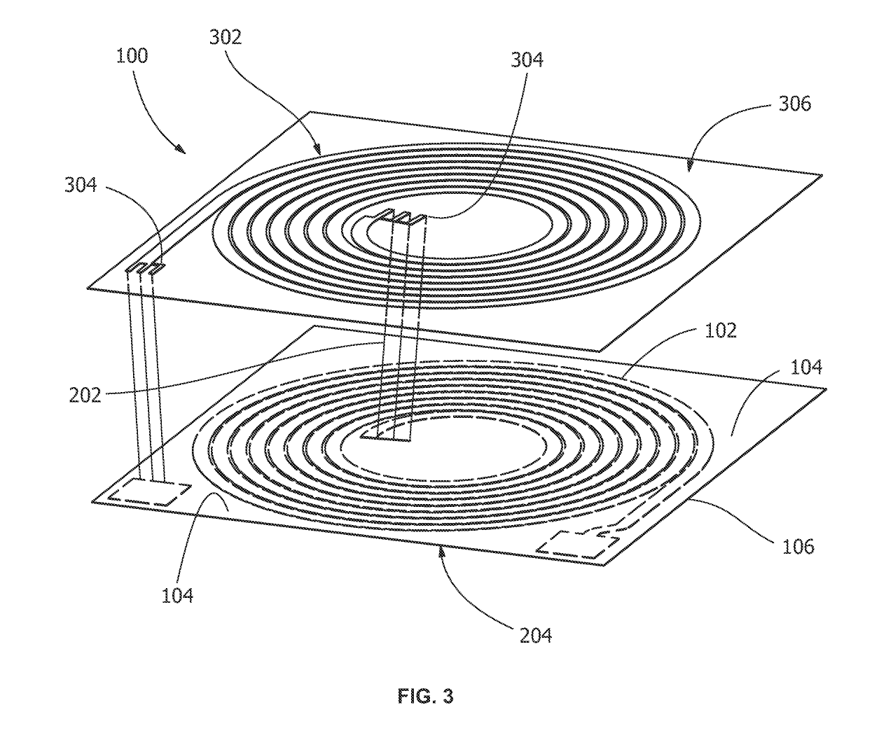

FIG. 3 shows a perspective view of another exemplary embodiment of the inductor 100. The inductor 100 includes the patterned metal layer 102 arranged on the first surface 104 of the insulating substrate 106. In addition, the inductor 100 includes a second patterned metal layer 302 arranged on a second insulating substrate 306. The second metal layer 302 is arranged on the first surface 104 or the second surface 204 of the second insulating substrate 306. In one embodiment, the second metal layer 302 is arranged on the second surface 204 and a third patterned metal layer (not shown) is arranged on the first surface 104 of the second insulating substrate 306. In one embodiment, a third patterned metal layer (not shown) is arranged on a third insulating substrate (not shown). In other embodiments, two, three, four, or more insulating substrates each having one or two metal layers are arranged on one or both surfaces of each insulating substrate providing any suitable number of turns within the inductor 100.

Referring again to FIG. 3, in one embodiment, the second patterned metal layer 302 is operably connected to the first patterned metal layer 102. In one embodiment, the second patterned metal layer 302 is connected to the first patterned metal layer 102 through a plurality of vias 304 generally extending from the first insulating substrate 106 to the second insulating substrate 306. For example, in one embodiment, the plurality of vias 304 includes three vias with the first patterned metal layer 102 and the second patterned metal layer 302 overlapping each via of the plurality of vias 304. In this embodiment, the plurality of vias 304 reduce or eliminate resistance caused by joining the first patterned metal layer 102 and the second patterned metal layer 302. The second patterned metal layer 302 includes any suitable features and/or properties described above with reference to the first patterned metal layer 102. The plurality of vias 304 include any suitable features and/or properties described above with reference to the via 202. The second insulating substrate 306 includes any suitable features and/or properties described above with reference to the first insulating substrate 106.

The first patterned metal layer 102 is operably connected to the first conductive pad 108 at one end of the pattern and the plurality of vias 304 at the other end of the pattern. The second patterned metal layer 302 is operably connected to the plurality of vias 304 at one end of the pattern and the second conductive pad 110 at the other end of the pattern, either directly or through an additional via. Through measurements of current between the first conductive pad 108 and the second conductive pad 110, the inductor 100 is capable of sensing changes in eddy current that, in turn, permit measurement by the eddy current sensor 400 (see FIG. 4).

The inductor 100 is fabricated by a direct-write process, a screen-printing process, an etching process, sputtering, evaporation, sintering, or combinations thereof. In one embodiment, the direct-write process is used to form the first patterned metal layer 102 on the insulating substrate 106, for example, as shown in FIG. 1. In this embodiment, the first conductive pad 108 and the second conductive pad 110 are written on the insulating substrate 106 and configured for external electrical connection, for example, by gold alloy brazing or white gold brazing. In one embodiment, the first patterned metal layer 102, first conductive pad 108, and the second conductive pad 110 are fired at an elevated temperature, such as 1300° C. (about 2372° F.), to stabilize the pattern. This elevated-temperature firing creates high mechanical peel strength, for example, being resistant to flaking or delamination under repeated cycles, based upon migration of the first pattern metal layer 102 into the insulating substrate 106. In the direct-write process, an additional step of depositing additional conductive material of the first patterned metal layer 102 and/or the second patterned metal layer 302 reduces resistance caused by the migration of the first patterned metal layer 102 and/or the second patterned metal layer into the insulating substrate 302, provides inductance consistency between portions of the inductor 100, and provides consistency between inductors 100 made through the direct-write process.

In one embodiment, the screen-printing process or the etching process is used to form the first patterned metal layer 102 on the first insulating substrate 106 and/or the second patterned metal layer 302 on the second insulating substrate 306, for example, as shown in FIG. 3. In this embodiment, the first patterned metal layer 102 and the plurality of vias 304 are formed on the first insulating substrate 106 and the second patterned metal layer 302 and the plurality of vias 304 are formed on the second insulating substrate 306. The first patterned metal layer 102, the second patterned metal layer 306 and the plurality of vias 304 are then fired at an elevated temperature, such as 1300° C. (about 2372° F.), to seal the plurality of vias 304, operably connect the first insulating substrate 106 and the second insulating substrate 306, and stabilize the pattern. This elevated-temperature firing creates high mechanical peel strength, for example, being resistant to flaking or delamination under repeated cycles, based upon migration of the first pattern metal layer 102 into the first insulating substrate 106 and/or the second patterned metal layer 302 into the second insulating substrate 306.

In the screen-printing process or etching process, an additional step of depositing additional conductive material of the first patterned metal layer 102 and/or the second patterned metal layer 302 reduces resistance caused by the migration of the first patterned metal layer 102 into the first insulating substrate 106 and/or the second patterned metal layer 302 into the second insulating substrate 304, provides consistency between portions of the inductor 100, and provides consistency between inductors 100 made through the screen-printing process or the etching process.

Referring to FIGS. 4 and 5, the eddy current sensor 400 is capable of measurement of current between the first conductive pad 108 and the second conductive pad 110 based upon changes in eddy current sensed by the inductor 100. The eddy current sensor 400 is capable of operation in any suitable region, for example, including, but not limited to, a gas turbine component, a steam turbine component, a combustion region, a high-temperature region, a hot manufactured product, or any other region. In one embodiment, the region is at a predetermined temperature, for example, up to about 500° C. (about 932° F.), up to about 800° C. (about 1472° F.), up to about 980° C. (about 1796° F.), up to about 1000° C. (about 1832° F.), up to about 1200° C. (about 2192° F.), up to about 1400° C. (about 2552° F.), up to about 1500° C. (about 2732° F.), between about −40° C. (about −40° F.) and about 500° C. (about 932° F.), between about −40° C. (about −40° F.) and about 980° C. (about 1796° F.), between about −40° C. (about −40° F.) and about 1000° C. (about 1832° F.), between about −40° C. and about 1500° C. In one embodiment, the region includes a predetermined humidity.

In one embodiment, the eddy current sensor 400 includes a transducer 401 having a first electrical lead 402, a first conductor 404, and a first cable 406 operatively coupled to the first conductive pad 108 of the inductor 100 and a second electrical lead 402, a second conductor 404, and a second cable 406 operatively coupled to the second conductive pad 110 of the inductor 100. The transducer 401 is coupled to a machine (not shown) for sensing dynamic data that may be correlated to a property measurable through eddy current, for example, a gap distance defined between the inductor 100 and a conductive or metallic target, such as, but not limited to, a rotating shaft of the machine, a gas turbine component, a steam turbine component, a combustion region, a high-temperature region, a hot manufactured product, or a component being monitored for material composition and/or material integrity.

The eddy current sensor 400 includes any other suitable components. For example, in one embodiment, the eddy current sensor 400 includes one or more resistors, filters, signal generators, timing control circuits, sampling circuits, convolution circuits, digital signal processors, microprocessors (for example, central processing units, application specific integrated circuits, logic circuits, or any other circuit or processor capable of executing an inspection system), other suitable components, or combinations thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An inductor, comprising:
a patterned metal layer arranged on an insulating substrate;
wherein the inductor is capable of sensing eddy current of a region, the region being at a temperature up to about 500° C.; and
wherein the patterned metal layer includes platinum.

2. The inductor of claim 1, wherein the inductor is capable of sensing eddy current with the temperature of the region being up to about 1000° C.

3. The inductor of claim 1, wherein the patterned metal layer includes a seed layer and a plating.

4. The inductor of claim 1, wherein the patterned metal layer includes a spiral pattern.

5. The inductor of claim 1, wherein the patterned metal layer includes 16 turns.

6. The inductor of claim 1, wherein the patterned metal layer includes a predetermined trace width between about 240 micrometers and about 267 micrometers.

7. The inductor of claim 1, wherein the patterned metal layer includes a predetermined trace spacing between about 216 micrometers and about 190 micrometers.

8. The inductor of claim 1, wherein the patterned metal layer includes a predetermined depth between about 19 micrometers and about 35 micrometers.

9. The inductor of claim 1, wherein the insulating substrate includes alumina.

10. The inductor of claim 1, wherein the insulating substrate includes aluminum nitride.

11. The inductor of claim 1, wherein the insulating substrate includes sapphire.

12. The inductor of claim 1, further comprising a via extending from the patterned metal layer positioned on a first surface to a second surface.

13. The inductor of claim 12, further comprising a first conductive pad on the first surface operably connected to the patterned metal layer and a second conductive pad on the second surface operably connected to the via.

14. The inductor of claim 13, wherein the first conductive pad includes one or more of a nickel-based alloy, a titanium-based alloy, a tungsten-based alloy, a gold-based alloy, and a molybdenum-based alloy.

15. The inductor of claim 1, further comprising a second patterned metal layer.

16. The inductor of claim 15, further comprising a second insulating substrate, wherein the second patterned metal layer is arranged on the second insulating substrate.

17. The inductor of claim 15, wherein the first patterned metal layer is operably connected to the second patterned metal layer through a plurality of vias.

18. An inductor, comprising:
a patterned metal layer on an insulating substrate;
a conductive material on the patterned metal layer;
wherein the inductor is capable of sensing eddy current of a region, the region being at a temperature up to about 500° C.

19. The inductor of claim 18, wherein the conductive material includes platinum.

20. An eddy current sensor, comprising
a transducer having an inductor, the inductor comprising:
a patterned metal layer arranged on an insulating substrate;
wherein the inductor is capable of sensing eddy current of a region, the region being at a temperature up to about 500° C.
